(19) United States
(12) Patent Application Publication
(10) Pub. No.: US 2004/0260537 A1
(43) Pub. Date: Dec. 23, 2004

(54) METHOD FOR CALCULATION A PITCH PERIOD ESTIMATION OF SPEECH SIGNALS WITH VARIABLE STEP SIZE

(76) Inventor: Gin-Der Wu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,761

(22) Filed: Oct. 24, 2003

(30) Foreign Application Priority Data
Jun. 9, 2003 (TW) 092115605

(51) Int. Cl. G10L 11/00

(52) U.S. Cl. 704/200

(57) ABSTRACT

A method for calculating the pitch estimation of speech signals. The method includes the following steps: (a) Providing an initial value to a lag parameter, (b) Calculating the autocorrelation values according to the lag parameters corresponding to the autocorrelation values, (c) Storing the lag parameter and the autocorrelation values corresponding to the lag parameters in a memory, (d) Determining a first increment value and a second increment value, (e) Comparing the autocorrelation values and the first threshold value in the step (b), (f) Repeat the steps (b), (c), (d) and (e), (g) Comparing the plurality of the autocorrelation values stored in the memory and finding out the maximum autocorrelation values, and calculating the pitch estimation with the lag parameter corresponding to the maximum autocorrelation value.

### BACKGROUND OF INVENTION

1. Field of the Invention

The present invention relates to a method for calculating a pitch estimation, and more specifically, to a method for calculation a pitch period estimation of speech signals with variable step size.

2. Description of the Prior Art

In the past few years electronic wireless communication has improved. At the same time the popularity of multimedia systems has increased while the demand for sound signal encoding and analyzing has become more and more popular. Sound telecommunication is an important application in the network of the next generation and has also an important role in multimedia telecommunications in the network.

Telecommunication is widely applied to the techniques of sound signal encoding. So the telecommunication of specification is quite important. At the moment, there are some specifications of the International Telecommunication Union: PCM(64 Kpbs), G711(64 Kpbs), G726 (ADPCM, 16, 24, 32, 40 Kpbs), G728(Low Delay CELP 16 Kpbs), G728(Low Delay CELP 8 Kpbs). Currently, the cellular mobile telephone systems in North American use VSELP encoding techniques of the TIA (Telecommunication Industry Association). The cellular mobile telephone systems in Japan and Europe use RPE-LTP encoding techniques such as JDC(Japanese Digital Cellular) and GSM(Global System for Mobil Telecommunication). At the moment the current encoding technique is still at 8 Kbps. But the encoding technique of a new generation of mobile telecommunications is at 4.8 Kbps (LD-CELP)-2.4 Kbps (MELP,STC). For achieving such a ratio, the operation complexity is also raised, so that the general digital signal processor is used to finish the immediate operation.

For matching the design, there are digital signal processors in the special application design for sound compression or sound identification. The features of the DSP are: a short instruction cycle, high parallelism and a plurality of special address modes to resolve the general digital signal processing.

The step with large amounts of operations in voice processing is the step of pitch estimation. This step is calculated according to equation 1.

$$R [ τ ] = {\sum }_{n = 0}^{N - 1} x [ n ] x [ n + τ ] \\ pitch period = \{ τ \vert max [ R [ τ ] ] \} \qquad \text{equation 1}$$

Equation 1 is the operation of the autocorrelation. X[n] is a sound signal comprising a plurality of voice data from x[0] to x[N−1]. Voice data x[n+ ] is a sound signal generated according to sound signal x[n] which lags a lag parameter. The sound signal x[n+ τ] is from x[ τ] to x[N−1+τ]. R[τis a autocorrelation value corresponding to a lag parameter. R[τ] is the value that the amount of the voice data in the sound signal x[n]times the corresponding voice data in the sound signal x[n+τ].

The autocorrelation operation in the method for estimating the pitch estimation, according to the prior art, calculates a plurality of autocorrelation value according to each lag parameter. Then a plurality of autocorrelation values are compared and the maximum autocorrelation value of these autocorrelation values are found. The lag parameter corresponding to the maximum autocorrelation value is used for calculating the pitch estimation.

Additionally, the normalizing autocorrelation method can also be used for estimating the pitch estimation. Please refer to equation 2.

$${R [ τ ]}^{2} = \frac{{[ {\sum }_{n = 0}^{N - 1} x [ n ] x [ n + τ ] ]}^{2}}{[ {\sum }_{n = 0}^{N - 1} {x [ n + τ ]}^{2} ]} \\ pitch period = \{ τ \vert max [ {Rn}^{2} [ n ] \} \qquad \text{equation 2}$$

The normalizing autocorrelation method calculates the value R[τ]² according to equation 2, i.e. the value R[τ]² is calculated according to each lag parameter τin a plurality of lag parameters τ. The values R[τ]² are stored in a memory and compared, until the maximum R[τ]² is found. Then a lag parameter τcorresponding to the maximum R[τ]² is used for estimating pitch estimation.

The amount of the operation of these two kinds of methods for estimating pitch estimation in digital signal processor is quite large. When the data bulk of the entry sound data is larger, the time of data processing is longer. When the sound signal cannot be operated immediately, the quality of the sound signal will be lowered.

### SUMMARY OF INVENTION

It is therefore a primary objective of the claimed invention to provide a method for calculating a pitch period estimation of speech signals with a variable step size.

The claimed invention provides a method for calculating pitch estimation of a sound signal with a voice processor, the sound signal comprising a plurality of sound data, the method comprising the following steps:(a) providing an initial value to a lag parameter; (b) using the voice processor to calculate an autocorrelation value according to the lag parameter; (c) storing the lag parameter and the corresponding autocorrelation value in a memory; (d) setting a first increment and a second increment; (e) using the voice processor to compare the autocorrelation values in step (b) with a first threshold value, wherein when the autocorrelation value is less than the first threshold value, the lag parameter is increased by the first increment, and when the autocorrelation value is larger than the first threshold value, the lag parameter is increased by the second increment; (f) repeating the step (b), step (c), step (d) and step (e) until the lag parameter is larger than a predetermined value; and (g) comparing the plurality of autocorrelation values stored in the memory to find a maximum autocorrelation value and calculating a pitch estimation of the sound signal according to the lag parameter corresponding to the maximum autocorrelation value.

### BRIEF DESCRIPTION OF DRAWINGS

FIG. 1 is a block diagram of a voice processor according to the invention.

FIG. 2 is a flowchart of a method for estimating a pitch estimation according to the invention.

FIG. 3 is a flowchart of a method for estimating a pitch estimation in the first embodiment in the invention.

### DETAILED DESCRIPTION

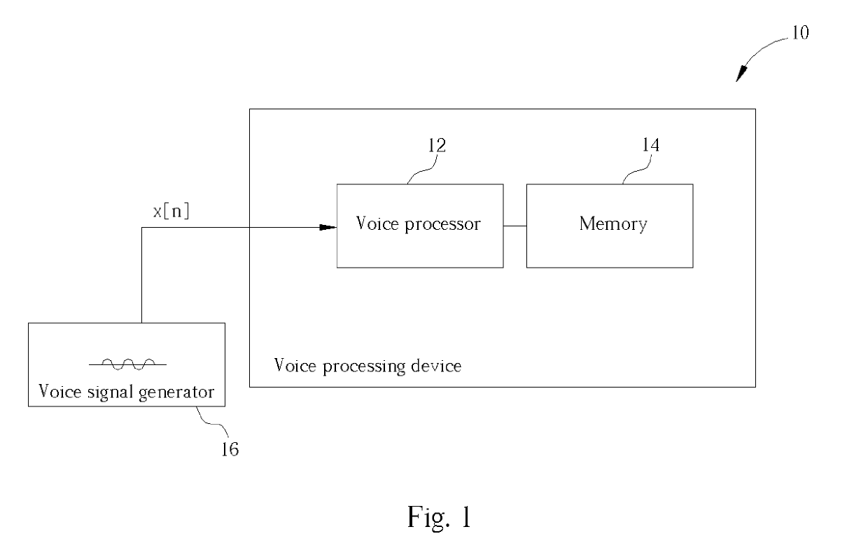

Please refer to FIG. 1. FIG. 1 is a block diagram of a voice processor 12 according to the present invention. A sound signal is an input in a voice processing device 10. The voice processing device 10 comprises a voice processor 12 for processing the sound signal x[n], a memory 14 for storing a plurality of lag parameters and autocorrelation values R[τ] calculated by the voice processing device 10 and a database for storing the sound signal x[n] and corresponding pitch range. The sound signal x [n] is generated by a sound signal generator 16 and input in the voice processing device 10.

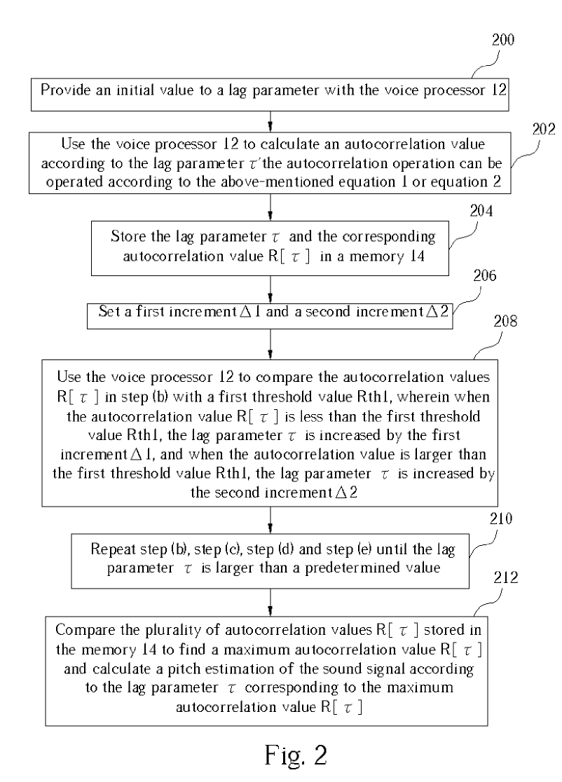

Please refer to FIG. 2. FIG. 2 is a flowchart of a method for estimating a pitch estimation according to equation 1 in the invention. The method comprises the following steps:

Step 200: Providing an initial value to a lag parameter with the voice processor 12;

Step 202: using the voice processor 12 to calculate an autocorrelation value according to the lag parameter τ;the autocorrelation operation can be operated according to the above-mentioned equation 1 or equation 2; Step 204: Storing the lag parameter τand the corresponding autocorrelation value R[τ] in a memory 14;

Step 206: Setting a first incrementΔ₁ and a second incrementΔ₂; Step 208: using the voice processor 12 to compare the autocorrelation values R[τ] in step (b) with a first threshold value Rₜₕ₁, wherein when the autocorrelation value R[τ] is less than the first threshold value Rₜₕ₁, the lag parameter τis increased by the first incrementΔ₁, and when the autocorrelation value is larger than the first threshold value Rₜₕ₁, the lag parameter τis increased by the second incrementΔ₂; Step 210: repeating step (b), step (c), step (d) and step (e) until the lag parameter τis larger than a predetermined value; and

Step 212: comparing the plurality of autocorrelation values R τ] stored in the memory 14 to find a maximum autocorrelation value R[τ] and calculating a pitch estimation of the sound signal according to the lag parameter τcorresponding to the maximum autocorrelation value R[τ].

In step 200 to step 204, the voice processor 12 is used for providing an initial value to a lag parameter τand calculating an autocorrelation value according to the lag parameter τ. The lag parameter τand the corresponding autocorrelation values R[τ] are stored in a memory 14. The initial value can be set as 1 or other value. In step 206 and step 208, a first increment Δ₁ and a second increment Δ₂ are set at first. The voice processor 12 compares the autocorrelation values R[τ] in step (b) with a first threshold value Rₜₕ₁. When the autocorrelation value R[τ] is less than the first threshold value Rₜₕ₁, the lag parameter τis increased by the first incrementΔ₁. When the autocorrelation value R[τ] is larger than the first threshold value Rₜₕ₁, the lag parameter τis increased by the second incrementΔ₂. The incrementΔ₂ is less than the incrementΔ₁. When the autocorrelation value R[τ] is larger than the first threshold value Rₜₕ₁, the lag parameter τis increased by the second incrementΔ₂. The purpose is to avoid ignoring the lag parameter τcorresponding to the pitch estimation. When the autocorrelation value is larger than a first threshold value Rₜₕ₁, the lag parameter corresponding to the autocorrelation value is close to the lag parameter corresponding to the pitch estimation of the sound signal and the second increment Δ₂ is increased by the lag parameter τ. The second incrementΔ₂ can be set as 1 or other value that is less than the first incrementΔ₁. When the autocorrelation value R[τ] is less than the first threshold value Rₜₕ₁, the lag parameter τis increased by the first incrementΔ₁. The purpose is to ignore some lag parameters τto reduce the amount of the autocorrelation operations. When the autocorrelation value is less than a first threshold value Rₜₕ₁, the lag parameter corresponding to the autocorrelation value is not close to a lag parameter corresponding to the pitch estimation of the sound signal and the second increment Δ₁ is increased by a lag parameter τ. The second incrementΔ₂ can be set as a larger value to ignore some lag parameters τto reduce the amount of the autocorrelation operations. The first increment can be adjusted according to a different system. In step 210, steps 202-208 are repeated. A plurality of autocorrelation values are calculated and stored in the memory 14 with a plurality of lag parameters. Because the autocorrelation is used for finding the level that the sound signal is similar to itself. When the sound signal is a cycle sound signal, the steps 202-208 are repeated until the lag parameter τis larger than the cycle number of the sound signal x[n]. When the sound signal is not a cycle sound signal, steps 202-208 are repeated until the lag parameter τis larger than the number of the sound signal x[n]. The autocorrelation operation for the non-cycle sound signal (ex: the noise or the sign) the autocorrelation values R[τ] or the square of the autocorrelation values R[τ]² cannot be used as the reference data for pitch estimation. Because the autocorrelation operation is used for finding the similar level between the sound signal and itself, a plurality of autocorrelation values of the cycle sound signal are showed in a regular pattern for finding the pitch estimation so that the pitch estimation can be found among the plurality of autocorrelation values. The autocorrelation values of the non-cycle sound signal are not showed in a regular pattern for finding the pitch estimation so that the pitch estimation of the sound signal cannot be found among the plurality of the autocorrelation values. In the embodiment, the autocorrelation operation is only operated in the cycle sound signal to find the pitch estimation.

In step 212, the voice processor 12 is used for comparing the plurality of autocorrelation values R[τ] stored in the memory 14 to find a maximum autocorrelation value R[τ] and calculating a pitch estimation of the sound signal according to the lag parameter τcorresponding to the maximum autocorrelation value R[τ]. The amount of the autocorrelation operations in the invention is less than the amount of the autocorrelation operations according to the prior art. The autocorrelation values are calculated according to each lag parameter τof a plurality of lag parameters τ. The lag parameter τis increased by the first increment Δ₁ or the second increment Δ₂ in the invention. When the lag parameter τis increased by the first increment Δ₁ or the second increment Δ₂, the lag parameter between the lag parameter τand the lag parameter τ+Δ₁ or the lag parameter τ+Δ₂ are omitted. The autocorrelation values corresponding to the omitted lag parameters can be set as zero or as a smaller number.

In the invention, a third increment or a plurality of increments can be set. The autocorrelation values in the step 202 are compared with a second threshold value Rₜₕ₂. The second threshold value Rₜₕ₂ is larger than the first threshold value Rₜₕ₁. When the autocorrelation value R[τ] is less than the second threshold value Rₜₕ₂ and larger than the first threshold value Rₜₕ₁, the lag parameter τis increased by the second incrementΔ₂. When the autocorrelation value R[τ] is larger than the second threshold value Rₜₕ₂, the lag parameter τis increased by the third incrementΔ₃.

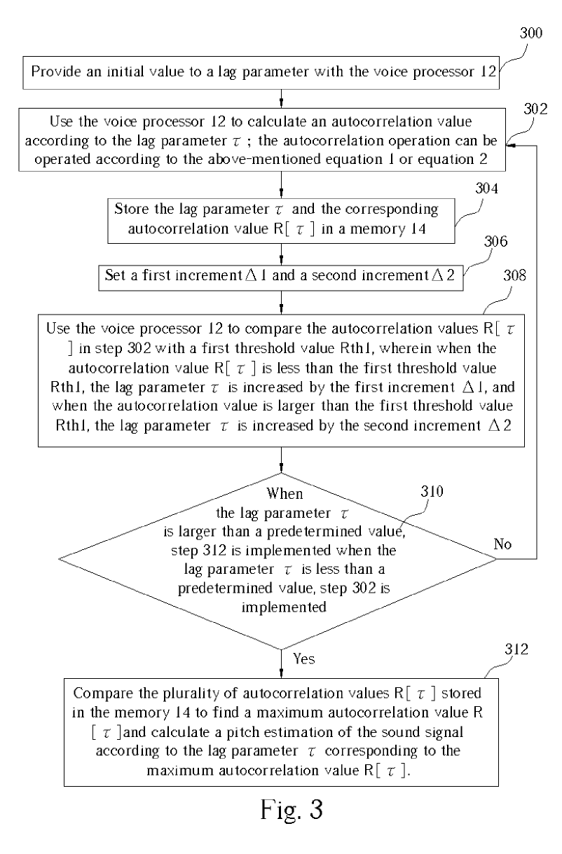

Please refer to FIG. 3. FIG. 3 is a flowchart of a method for estimating a pitch estimation in the first embodiment of the invention. The embodiment is implemented in the voice processor 10.

Step 300: Providing an initial value to a lag parameter with the voice processor 12; Step 302: using the voice processor 12 to calculate an autocorrelation value according to the lag parameter τ; the autocorrelation operation can be operated according to the above-mentioned equation 1 or equation 2; Step 304: Storing the lag parameter τand the corresponding autocorrelation value R[τ] in a memory 14;

Step 306: Setting a first incrementΔ₁ and a second incrementΔ₂; Step 308: using the voice processor 12 to compare the autocorrelation values R[τ] in step 302 with a first threshold value Rₜₕ₁, wherein when the autocorrelation value R[τ] is less than the first threshold value Rₜₕ₁, the lag parameter τis increased by the first increment Δ₁, and when the autocorrelation value is larger than the first threshold value Rₜₕ₁, the lag parameter τis increased by the second increment Δ₂; Step 310: when the lag parameter τis larger than a predetermined value, step 312 is implemented; when the lag parameter τis less than a predetermined value, step 302 is implemented; and Step 312: comparing the plurality of autocorrelation values R[τ] stored in the memory 14 to find a maximum autocorrelation value R[τ] and calculating a pitch estimation of the sound signal according to the lag parameter τcorresponding to the maximum autocorrelation value R[τ]. The amount of the autocorrelation operations in the invention is less than the amount of the autocorrelation operations according to the prior art. The autocorrelation values are calculated according to each lag parameter τof a plurality of lag parameters τ. The lag parameter τis increased by the first increment Δ₁ or the second increment Δ₂ in the invention. When the lag parameter τis increased by the first increment Δ₁ or the second increment Δ₂, the lag parameter between the lag parameter τand the lag parameter τ+Δ₁ or the lag parameter τ+Δ₂ are omitted so that the amount of operations can be reduced. And the lag parameter increases less for the second increment Δ₂ to avoid omitting the interval that the pitch estimation is probably in.

Those skilled in the art will readily observe that numerous modifications and alterations of the device may be made while retaining the teachings of the invention. Accordingly, the above disclosure should be constructed as limited only by the metes and bounds of the appended claims.

1. A method for calculating pitch estimation of a sound signal with a voice processor, the sound signal comprising a plurality of sound data, the method comprising the following steps:
(a) providing an initial value to a lag parameter;
(b) using the voice processor to calculate an autocorrelation value according to the lag parameter;
(c) storing the lag parameter and the corresponding autocorrelation value in a memory;
(d) setting a first increment and a second increment;
(e) using the voice processor to compare the autocorrelation values in step (b) with a first threshold value, wherein when the autocorrelation value is less than the first threshold value, the lag parameter is increased by the first increment, and when the autocorrelation value is larger than the first threshold value, the lag parameter is increased by the second increment;
(f) repeating step (b), step (c), step (d) and step (e) until the lag parameter is larger than a predetermined value; and
(g) comparing the plurality of autocorrelation values stored in the memory to find a maximum autocorrelation value and calculating a pitch estimation of the sound signal according to the lag parameter corresponding to the maximum autocorrelation value.

2. The method of claim 1 wherein the second increment is less than the first increment in step (d).

3. The method of claim 1 wherein the initial value is equal to 1 in step (a).

4. The method of claim 1 wherein the predetermined value is equal to a cycle number of the digital sound data.

5. The method of claim 1 wherein step (d) further comprises setting a third increment and step (e) further comprises using the voice processor to compare the autocorrelation value generated in step (b) and a second threshold value that is larger than the first threshold value, wherein when the autocorrelation value is less than the second threshold value and larger than the first threshold value, the second increment is added to the lag parameter, and when the autocorrelation value is larger than the second threshold value, the third increment is added to the lag parameter.

6. A voice processing device for implementing the method of claim 1.
